(19) United States
(12) Patent Application Publication
(10) Pub. No.: US 2017/0031052 A1
(43) Pub. Date: Feb. 2, 2017

(54) Electromagnetic System for Exploring the Seabed

(71) Applicants: Universite De Bretagne Occidentale - UBO, Brest (FR); Centre National de la Recherche Scientifique - CNRS, Paris (FR)

(72) Inventors: Jean-Francois D'eu, Lanildut (FR); Pascal Tarits, Landunvez (FR); Fabien Gaspari, Brest (FR)

(73) Assignees: Universite De Bretagne Occidentale - UBO, Brest (FR); Centre National de la Recherche Scientifique - CNRS, Paris (FR)

(21) Appl. No.: 15/292,630

(22) Filed: Oct. 13, 2016

Related U.S. Application Data
(63) Continuation of application No. 14/371,295, filed on Feb. 19, 2015, now abandoned.

(30) Foreign Application Priority Data
Jan. 9, 2012 (FR) 1250221

(51) Int. Cl. G01V 3/15; G01V 3/08; G01V 3/02

(52) U.S. Cl. CPC G01V 3/15; G01V 3/02; G01V 3/083

(57) ABSTRACT

An electromagnetic system for exploring the seabed in a marine environment includes a current injection module with two electrodes spaced apart from one another, said injection electrodes being capable of injecting a current at a predetermined voltage into the marine environment close to the seabed, said injection electrodes having a contact surface with the marine environment. The system includes a data acquisition module with at least two measuring sensors for measuring electrical or magnetic data at least two points of the marine environment close to the seabed, and a power supply module for supplying power to the current injection module. Each electrode includes one or more separate conductive elements that are electrically connected to each other and arranged in such a way as to form a conductive network or a multilayer conductive assembly having a large contact surface with the marine environment.

### BACKGROUND

This application is a continuation of U.S. patent application Ser. No. 14/371,295 filed Feb. 19, 2015, which was a National Stage filing of International Application No. PCT/EP2013/050316 filed Jan. 9, 2013, which claimed priority to French Patent Application No. 1250221 filed Jan. 9, 2012, the entire contents of each are incorporated herein by reference.

This invention relates to an electromagnetic system for exploring the seabed making it possible to collect data that represents the electrical structure of the seabed over penetration depths of a few hundred metres. This system is more particularly used to collect resistivity data over the first few metres or the first few tens of metres of the seabed.

### SUMMARY

Techniques for electromagnetic marine exploration are known in fundamental research and also for the search for hydrocarbons or the search for gas hydrates, as described in the document entitled “A marine deep-towed DC resistivity survey in a methane hydrate area, Japan Sea” by T. N Goto, T. Kasaya, H. Machiyama, R. Takagi, R. Matsumoto, Y. Okuda, M. Satoh, T. Watanabe, N. Seama, H. Mikada, Y. Sanada, M. Noshita, in Exploration Geophysics, 2008, 39, 52-59; Butsuri-Tansa, 2008, 61, 52-59; Mulli-Tamsa, 2008, II, 52-59. These techniques consist in measuring the electrical properties of materials forming the seabed, i.e. their propensity to allow or not allow an electric current to pass. In practice, currents are injected or are induced into the environment to be analysed and at different points of this environment the electrical potentials or the magnetic fields resulting from the electrical or electromagnetic excitation caused by the flow of the current in this environment are measured in order to, after inverting the data, deduce from it the electrical resistivity profile of the seabed.

The techniques for electromagnetic exploration are commonly used on land. They were then adapted to the marine environment in order to study the internal structure of the land at depths between about ten and a few hundred of kilometres and for oil exploration with depths of a magnitude of a few kilometres. This adaptation to the marine environment for depths beyond the kilometre has substantially consisted in using systems comprising measuring sensors positioned on the seabed, that record the injected or induced signal generated by a fixed source or a source drawn by a vessel above sensors. When the depth of the seawater is shallow (less than a few metres), the systems used at sea are generally land devices, with the latter being arranged aboard the exploration vessel, with the means for injecting the current and the means for measuring being towed at the surface or on the seabed.

These systems for exploring conventionally comprise:

a current injection module comprising two injection electrodes separated from one another in order to inject, into the seabed or into the marine environment close to this seabed, a current at a predetermined voltage and a unit for controlling the injection,

a data acquisition module comprising at least two measuring sensors for measuring electrical data, generally electrical potentials, at least two points of the seabed or of the marine environment close to this seabed, with the electrical data measured resulting from the flow of the current in the seabed, and means for storing and/or analysing said electrical data; and

a supply module for supplying power to the current injection module.

In the marine systems intended for exploring for hydrocarbons, the current injected into the marine environment is conventionally a low-frequency alternating-current voltage having a peak-to-peak amplitude of a magnitude of a few tens to a few hundreds amperes, with this current being injected into the seabed at a voltage of a magnitude of a few hundred peak-to-peak volts. The intensity of this current is relatively strong in order to reach depths in terms of kilometres. This current is supplied by the supply module which is either arranged aboard the vessel, or arranged in a sealed compartment of the undersea vehicle, said supply module is supplied by an electric generator present aboard the vessel in operation and delivering an alternating- current voltage of a magnitude of the kilovolt. In practice, the supply module is an AC/AC convertor in charge of converting the high voltage produced by the electric generator into a lower voltage. It is very voluminous as it must be able to deliver power levels of several thousands of watts. The system is therefore also very voluminous and implementing it therefore generally requires the use of vessels of large size that have substantial electrical power and, if a portion of the system is offset onto an undersea vehicle, substantial means for putting the undersea vehicle into water and towing it. Injection electrodes are generally very long and have for example the form of a hollow tube several tens of metres in length.

The invention relates to a technical field other than oil exploration or the search for gas hydrates. It relates to the analysis of the first few metres or first few tens of metres of the seabed, commonly referred to as near surface, and aims more particularly to propose an electromagnetic system for exploring that makes it possible to collect electrical data from the near surface of the seabed.

The invention is moreover part of an approach in reducing the size of the electromagnetic system for exploring in such a way as to obtain a compact and light system that can be used by vessels of small size that do not necessarily have substantial electrical power.

However, the measurement accuracy of electromagnetic systems for exploring depends in part on the intensity of the current injected into the marine environment. Indeed, as the marine environment is highly conductive, the potentials measured by the system are very low. Injecting a high current is therefore required in order to maintain the quality of the electrical data measured. It is therefore preferable to not decrease the intensity of the current injected for decreasing the electrical power to be supplied.

According to the invention, in order to reduce the volume of the electromagnetic system for exploring, it is proposed to reduce the electrical power required for injecting the current by decreasing the voltage at which the current is injected into the marine environment. As the injection is carried out in seawater, the current injected I is proportional to the voltage U at the terminals of the injection electrodes, by applying Ohm's law, with R being the total electrical resistance of the injection module of the system. For a given current I, a decrease in the voltage U can therefore be obtained by decreasing the electrical resistance R of the injection module.

In order to decrease the electrical power required for the injection module, it is proposed to decrease the electrical resistance of the injection module by increasing the surface of the injection electrodes which is in contact with the marine environment while also increasing the compactness of the system.

More particularly, it is proposed to use injection electrodes that have a contact surface with the marine environment such that the electrical resistance of the injection electrodes is less than 0.5 Ohms, more preferably less than 0.2 Ohms.

The invention therefore has for object an electromagnetic system for exploring a seabed located in a marine environment, comprising:

a current injection module comprising two conducting electrodes separated from one another, referred to as injection electrodes, able to inject a current at a predetermined voltage into the marine environment close to the seabed, and a unit for controlling the injection, said injection electrodes having a contact surface with the marine environment,

a data acquisition module comprising at least two measuring sensors for measuring electrical or magnetic data at least two points of the marine environment close to the seabed, said data resulting from the conduction or from the induction of the current into the seabed,

a supply module for supplying power to the current injection module,

remarkable in that each injection electrode comprises one or several separate conductive elements that are electrically connected to each other and arranged in such a way as to form a conductive network or a multilayer conductive assembly having a large contact surface with the marine environment.

Advantageously, the contact surface of each of the injection electrodes is greater than or equal to 0.5 m².

Advantageously, the contact surface of the two electrodes is dimensioned so that the electrical resistance of the injection electrodes is less than 0.5 Ohm and more preferably less than 0.2 Ohm.

The multilayer arrangement or as an electrode network makes it possible to obtain a compact injection electrode.

Conductive network means an assembly wherein one or several conductive elements is or are arranged in a limited space.

Advantageously, each injection electrode is comprised inside of a volume of which the greatest length is less than 1.5 metres.

According to the invention, the resistance of the injection electrodes is reduced in order to decrease the voltage at which the current is injected into the marine environment and reduce the electrical power to be provided by the supply module. To this effect, injection electrodes are used that have a contact surface with the marine environment which is relatively extended, greater than 0.5 m² in order to reduce the electrical resistance of the injection electrodes in contact with the marine environment to approximately 0.1 Ohm.

In order to further reduce the global resistance of the current injection module, also as much as possible, in the current injection module, the size and the number of cables and the number of connectors will be reduced and active components with little resistance will be used. According to a particular embodiment, the electrical resistance of the cables, of the connectors and of the active components of the unit for controlling the injection module are reduced as such to approximately 0.2 Ohms.

All of these measures can make it possible to reduce the total resistance of the current injection module to approximately 0.3 Ohms or even less. According to the invention, a current of a magnitude of 40 A can then be injected at a reduced voltage, for example 12V. The electrical power delivered by the supply module is then reduced to about 500 W.

This supply module, advantageously arranged in an undersea vehicle, can be supplied with power by a generator of small size arranged aboard the exploration vessel that delivers for example the normal alternating-current voltage between 100 and 230 V.

Advantageously, the voltage at which the current is injected into the marine environment is less than or equal to 60 volts. This voltage is far below the voltages that are conventionally used for oil exploration. For this voltage value, it is possible to inject into the marine environment a stronger current for example 200 A for a resistance of the injection electrodes of 0.1 Ohm or about 85 A for a resistance of the injection electrodes of 0.5 Ohm.

According to an advantageous embodiment, each injection electrode comprises a plurality of conductive elements arranged next to one another and electrically connected to each other in such a way as to form a multilayer conductive assembly. According to a particular embodiment, the conductive elements are metal plates arranged substantially parallel to each other.

According to an embodiment, the conductive elements are perforated and comprise, at least in a central portion, a plurality of holes passing through said plate in such a way as to obtain an open system and in such a way that the lines of current extending from the plates arranged between the two end plates are in contact with a maximum of liquid of the marine environment. The use of grilles falls within the scope of this embodiment.

Alternatively, the conductive elements are manufactured from a metal fabric or stainless-steel wire wool.

According to an embodiment, the injection electrodes are made of a conducting material of the brass, copper, stainless steel, graphite, titanium or platinum type. They are possibly plated with a stainless material such as gold.

Advantageously, the injection electrodes are made from a porous conducting material in order to further increase the contact surface of the electrodes without increasing their volume or their weight.

According to another embodiment, each injection electrode comprises a conductive element made of a metal fabric or of a porous conducting material.

According to an embodiment, the contact surfaces of the two injection electrodes have surface areas that are substantially identical. Alternatively, they can be different.

According to an embodiment, the supply module is arranged in a sealed compartment of an undersea vehicle towed by a vessel and able to be moved in the marine environment close to the seabed.

According to an embodiment, one of the two injection electrodes is mounted on said undersea vehicle and the other injection electrode is mounted at the end of a trawl towed by said undersea vehicle. The weight in the water of the trawl is offset by adding floatability.

Advantageously, the surface area of the contact surface of the injection electrode mounted on the undersea vehicle is less than that of the other electrode in order to make it the most compact possible and increase the resolution of the exploration.

The trawl can be instrumented with attitude sensors, an altimeter and pressure sensors in order to know its relative position in relation to the undersea vehicle which can also be provided with the same sensors.

According to an embodiment, the measuring sensors are arranged along a cable towed by the undersea vehicle.

### BRIEF DESCRIPTION OF THE DRAWINGS

The invention shall be better understood, and other purposes, details, characteristics and advantages shall appear more clearly in the following detailed explanatory description, by referring hereinabove to the annexed drawings, which show:

FIG. 1, an overall diagrammatical view showing the system according to the invention in operating condition, with said system comprising an undersea vehicle or fish towed by a vessel and a cable carrying measuring sensors and pulling a trawl carrying a current injection electrode;

FIG. 2, an enlarged view of a detail A of FIG. 1 showing more particularly the fish;

FIG. 3, a perspective view of a fish in accordance with the invention;

FIG. 4, a longitudinal cross-section view of the fish of FIG. 3;

FIG. 5, a rear view of the fish of FIG. 3;

FIG. 6, a perspective view of the trawl of the system of FIG. 1, and

FIG. 7 is a diagrammatical view of an alternative embodiment of the injection electrode of the system of the invention.

The invention proposes an electromagnetic system for exploring of reduced dimensions that can be implemented by vessels of small size that do not have substantial electrical power available. For this, it comprises a current injection module that has very reduced resistive losses which makes it possible to reduce the electrical power required to inject current into the marine environment. In order to reduce the total electrical resistance R of the current injection module, action is taken on the resistance R_{c} of the conducting cables and connectors of the module, the resistance Rₑ₁, of the active components of the module and the resistance Rₑ₂ of the injection electrodes of the module. The resistance R then shows the sum of the resistances R_{c}, Rₑ₁ and Rₑ₂.

In order to reduce the resistance R_{c}, the diameter of the conducting cables is increased and the size of the cables is reduced as much as possible. The number of connectors is also reduced and connectors having good quality contacts are used. It is thus possible to reduce the resistance R_{c} to a value of a magnitude of 0.1 Ohm for a distance of 100 metres between the electrodes.

In order to reduce the resistance Rₑ₁, active components (transistors) are used that have little electrical resistance, of a magnitude of a few milli-Ohms. It is thus possible to also reduce the resistance Rₑ₁, to a value less than 0.1 Ohm.

Finally, in order to reduce the resistance Rₑ₂, the contact surface of the electrodes with the marine environment is increased. Indeed, the resistance Rₑ₂ comprises the electrical resistance of the material used for the manufacture of the electrode and especially the contact resistance with the seawater. The latter is the most important and attentions need to be given to reducing this.

Indeed, the resistance of the injection module is generally dominated by the resistance of the layer of water in contact with the electrodes. The resistivity of seawater is of a magnitude of 0.3 Ohm.m, which, although very low in relation to the normal land materials, is very high compared to the resistivity of the metal of the electrode. It is therefore the surface of the seawater in contact with the electrode that dimensions the resistance of the injection electrodes. As such, by increasing the surface of the electrodes in contact with the marine environment, decreasing the resistance Rₑ₂ is achieved.

As such, if it is desired to inject a current of 40 Amperes at a voltage of 12V, the total resistance of the current injection module has to be 0.3 Ohms. If the electrical resistance (R_{c}+Rₑ₁) of the cables and active components of the current injection module is equal to about 0.2 Ohms, a resistance Rₑ₂ of a magnitude of 0.1 Ohms is required so that the total resistance R of the current injection module does not exceed 0.3 Ohms.

We shall provide details hereinafter on how to determine the contact surface required in order to obtain a resistance Rₑ₂ equal to 0.1 Ohms. The material used for the electrodes must of course be a good conductor. The electrolysis that occurs with the passage of the direct or alternating current on the surface of the electrodes makes it possible to at least partially eliminate the possible layer of oxide that could be deposited on the surface of the electrodes. Copper, brass, stainless steel, graphite or more expensive metals such as titanium, platinum, gold or silver can be used in order to manufacture the electrodes. The calculation of the contact surface of the electrodes is described hereinafter in the scope of electrodes with a spherical symmetry. This form allows for a relatively simple calculation and tests have shown that this calculation is valid for electrodes of different shapes.

For this calculation, two spherical injection electrodes are considered, noted as E1 and E2, having a radius r. For each of these electrodes, the variation of potential ΔV is zero, giving

$$Δ V = \frac{1}{{r}^{2}} \frac{d}{d r} ( {r}^{2} \frac{d V}{d r} ) = 0$$

(Laplace's equation)

Thus

$$\frac{d V}{d r} = - \frac{B}{{r}^{2}}$$

where B is an integration constant.

However if the following equations that define the electrical field \vec{E} are considered, the current density \vec{j} and the current intensity I

$$\vec{E} = - \vec{grad} ( V ) = - \frac{d V}{d r} \vec{r}$$

$$\vec{j} = σ \cdot \vec{E}$$

$$I = \int \vec{j} \cdot \vec{d} s = 4 π {r}^{2} ‖ \vec{j} ‖$$

The following is thus obtained:

$$V = \frac{I}{4 πσ r}$$

If the potential of the electrode E1 and the potential of the electrode E2 are designated respectively by V1 and V2, we have the resulting voltage Uₑ of the electrical resistance Rₑ₂ of the electrodes which is equal at the terminals of the electrodes to

$$σ = \frac{1}{0.3 ohm . m}$$

The resistance Rₑ₂ is therefore equal to

$${U}_{e} = {V}_{1} - {V}_{2} = {R}_{e 2} \cdot I with {V}_{1} = \frac{I}{4 πσ r} and {V}_{2} = \frac{I}{4 πσ r} .$$

With the surface S of the electrodes equal to S=4π², we then have

$$R = \frac{{V}_{2} - {V}_{1}}{I} = \frac{1}{2 πσ r}$$

So S=2.86 m² for Rₑ₂=0.1 Ohm and

$$S = \frac{1}{π \cdot {σ}^{2} \cdot {R}_{e 2}^{2}}$$

A contact surface of approximately 3 m² is therefore required to achieve the desired injection performance, namely 40 A at 12 volts.

According to another example, for a current of 30 A at 12 volts, a total resistance R of the injection module of 0.4 Ohm is required. If the values R_{c}=0.1 Ohm and Rₑ₁=0.1 Ohm are retained, imperatively Rₑ₂=0.2 Ohm, which is a contact surface S of a magnitude of 0.7 m².

According to the invention, this substantial contact surface is obtained by using electrodes that have the form of conductive elements such as metal plates. So that the system remains compact, each electrode comprises advantageously a plurality of conductive elements arranged next to one another and electrically connected to each other. According to the invention, these elements are more preferably perforated and comprise to this effect multiples holes so that the electrode is an open system and that the lines of current extending from the plates arranged between the end plates are in contact with a maximum of liquid of the marine environment. These elements can also be made from a porous material or in the form of a metal fabric or metal grilles.

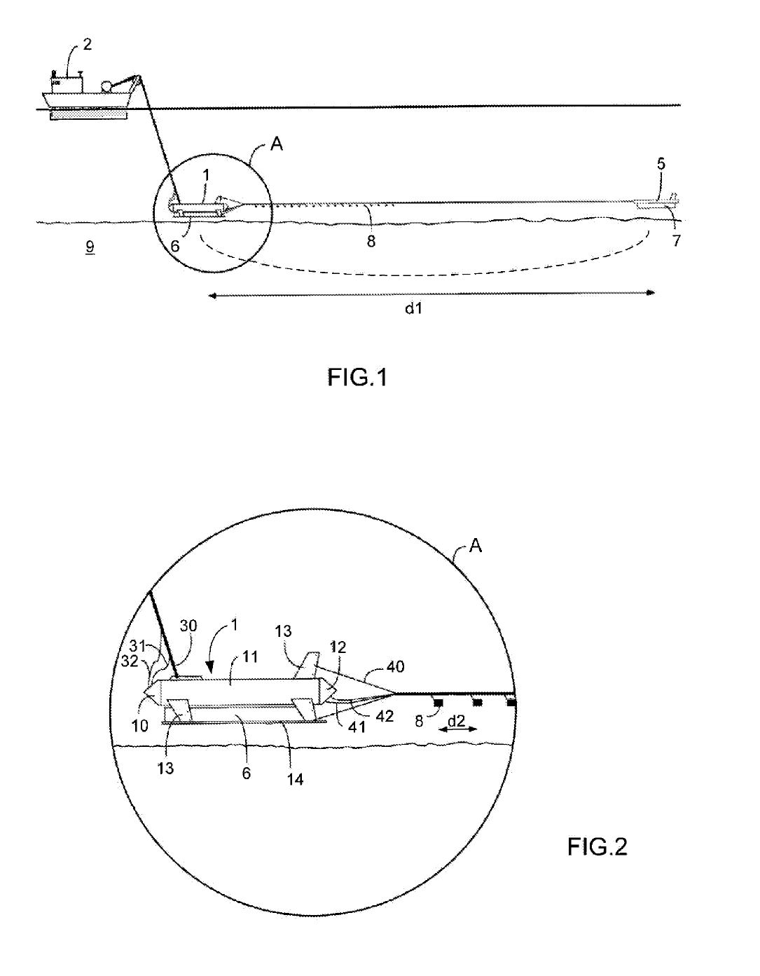

FIGS. 1 to 6 show an electromagnetic system for exploring in accordance with the invention.

In reference to FIGS. 1 and 2, the electromagnetic system for exploring according to the invention comprises an undersea vehicle, called a fish 1, towed by a vessel 2 by means of a cable 30. A supply cable 31 in order to supply power to the fish and a data cable 32 for transmitting data are arranged along the cable 30 or inside the latter. The fish 1 is extended by a cable 40 intended to pull a profiled trawl 5 for undersea navigation. Current injection electrodes 6 and 7 are arranged respectively on the fish 1 and the trawl 5 in order to inject a current into the marine environment close to the seabed 9. The injection electrode 6 is directly mounted on the fish 1. The injection electrode 7 arranged on the trawl 5 is connected to the fish via an injection return cable 41 arranged along the cable 40.

A measuring cable 42 provided with measuring sensors 8 is connected to the fish in order to measure the electrical potentials at different points of the marine environment. As with the cable 41, the cable 42 is arranged along the cable 40. These cables are for example maintained along the cable 40 by means of a sock. The length of the cable 41, which substantially corresponds to the distance d1 between the two injection electrodes 6 and 7, defined the investigation depth of the system while the distance d2 between the measuring sensors 8 of the cable 42 define the lateral resolution and the resolution in depth of the system.

As the electrode 7 here is very far from the electrode 6 and measuring sensors 8, it is considered as an infinite ground electrode. The system is therefore of the pole-dipole type well known to those skilled in the art. All of the other types of devices for the relative organisation of the sensors and of the device for injection in relation to one another are also possible without restriction and fall within the scope of the invention.

In reference to FIGS. 2 to 5, the fish 1 has the form of a cylindrical tube 11 provided with a head 10 and a tail 12 with both having the shape of a missile. The cylindrical tube 10 is provided with five fins 13, of which three at the rear are offset angularly by about 120° and two at the front. The two front fins are arranged in the longitudinal planes of the two rear fins present in the lower portion of the fish.

The cable 30 is fixed to the front of the fish and the cable 40 is fixed to the three rear fins of the fish.

The injection electrode 6 is mounted on a support 14 fixed to the four fins 13 arranged in the lower portion of the fish. The electrode 6 comprises a plurality of substantially identical metal plates 60 mounted on the support 14. These plates are arranged vertically and are separated from one another by spacers 61. The spacers are conductive and provide the electrical connection between the plates 60.

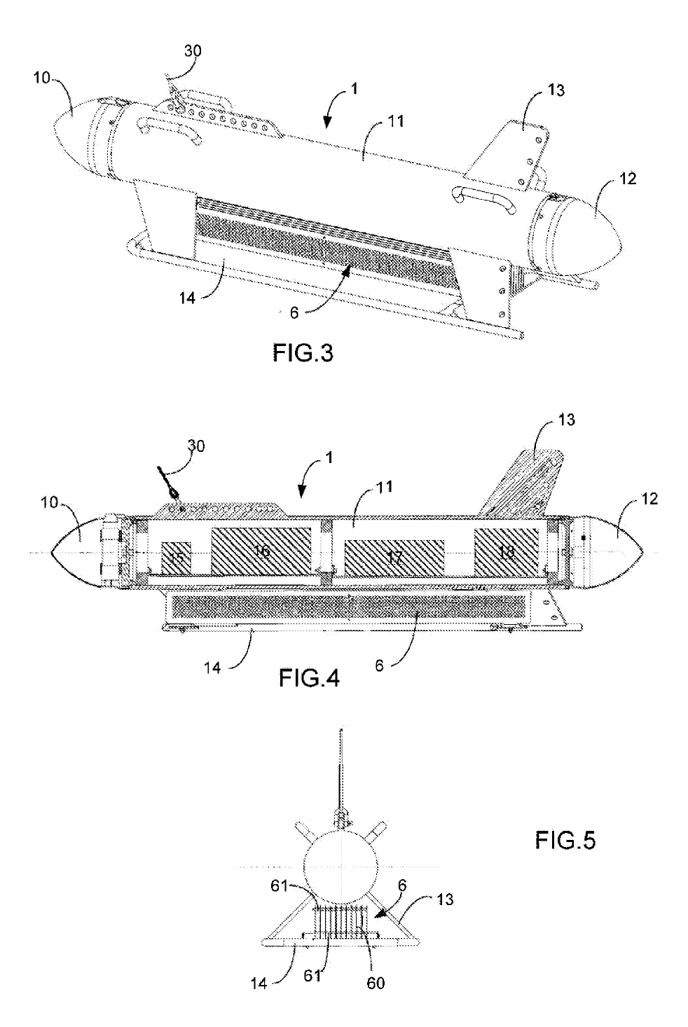

As shown more particularly in FIGS. 3 and 4, the plates 60 are more preferably provided with holes 62 so that the lines of current of the intermediate plates arranged between the end plates 2 are in contact with a maximum of liquid of the marine environment. This has for advantage to lighten the system without substantially decreasing the contact surface of the plates since contact surface is recovered on each hole in the thickness of the plate.

According to an alternative shown in FIG. 7, each of the injection electrodes 80 of the system has the form of a metal fabric made from one or several entwined metal wires, said wire or wires being arranged inside a predefined volume. In this figure, the electrode 80 is of parallelepiped shape. A metal plate of which an end is arranged inside the parallelepiped is used to connect the fabric inside the parallelepiped with the rest of the current injection module.

This electrode is for example made using one or several wires made of braided stainless steel in order to form a parallelepiped. Of course, other forms of electrodes can be considered, for example a cylindrical form. Conductive materials other than stainless steel can also be used.

In the example of FIG. 7, the electrode is carried out using a plurality of entwined metal wires. The parallelepiped has the following dimensions: length=0.4 m; width=0.3 m and height=0.1 m. It makes it possible to obtain a contact surface between 4 and 5 m².

As shown diagrammatically in FIG. 4, the fish comprises, inside the tube 11, a data transmission circuit 15, a supply module 16, a data acquisition circuit 17 and a current injection circuit 18. The data transmission circuit 15 is connected on the one hand to the data transmission cable 32 coming from the vessel and to the data acquisition circuit 17. The supply module 16 is connected to the supply cable 31 coming from the vessel. The data acquisition circuit 17 is connected to the measuring cable 42 and forms with the latter a data acquisition module. Likewise, the current injection circuit 18 is connected to the electrode 6 and to the electrode 7 via the injection return cable 41, said elements together form a current injection module. The fish is instrumented to be moved close to the seabed 9.

The circuits 15, 17 and 18 are supplied with power by the supply module 16. The supply module provides in particular the injection current to the current injection circuit 18. The latter comprises the switching electronics (transistors) that make it possible to supply the current delivered by the supply module 16 to the marine environment via the electrodes 6 and 7. The data acquisition circuit 17 comprises the control electronics of the measuring sensors, means for storing the signals measured, and possibly means for analysing or pre-analysing the signals measured. Finally, the data transmission circuit 15 transmits the signals measured to the vessel.

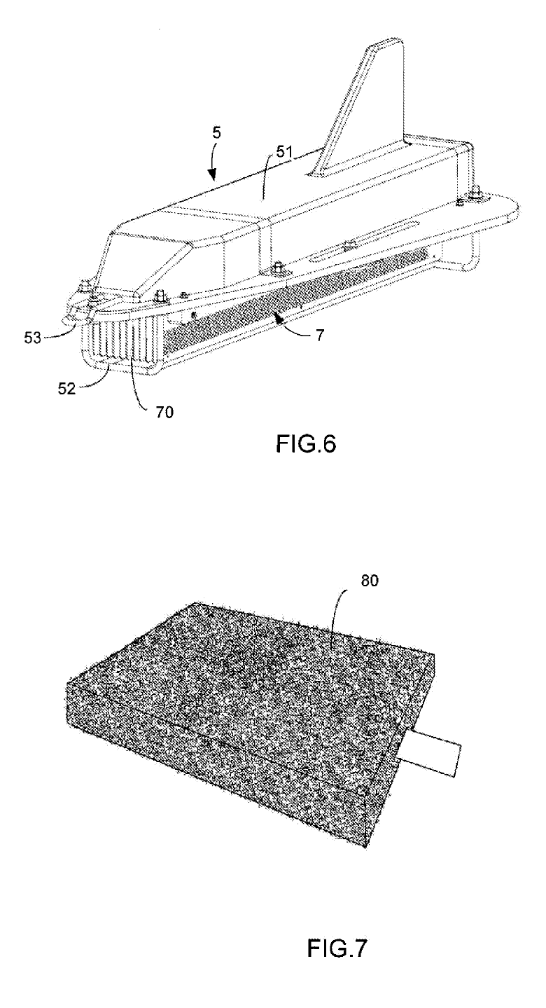

The second injection electrode 7 mounted on the trawl 5 is described in reference to FIG. 6. The trawl 5, of a form profiled for undersea navigation, comprises a body 51 in the form of an aircraft carrying the injection electrode 7. The body 51 is provided with, at one of its ends, a ring 53 in order to fix the cable 42 to the trawl 5. It is also provided with means, such as an enclosure filled with air or foam, which confers zero floatability in seawater. Moreover, as with the electrode 6, the electrode 7 comprises a plurality of substantially identical metal plates 70. The plates are fixed by their upper edges to the body 51. Roll-over bars 52 extending downwards from the body 51 is provided to protect the plates in the event where the trawl would touch the seabed or an obstacle. These plates are arranged vertically and are separated from one another by spacers not shown. The electrical connection between the plates 70 is carried out by the spacers.

In the embodiment shown in FIGS. 3 to 6, the system comprises nineteen measuring sensors 8 separated by about 1 metre from each other and the distance d1 between the injection electrodes is about 100 metres. An investigation depth between 20 and 30 metres is as such obtained. The fish measures 1.50 m in length for a diameter of 20 cm. The electrode 6 comprises 11 plates 60 of 1 m×0.1 m. The trawl 5 measures 1.10 m in length and comprises 10 plates 70 of 1 m×0.1 m. The plates are perforated in their central portion. A total contact surface of a magnitude of 2 to 3 m² is thus obtained making it possible to inject a current of 40 amperes at 12 volts into the marine environment. This has been confirmed by tests conducted at sea.

In the system tested, the fish is supplied with 220 alternating-current volts and the supply module 16 converts the alternating tension into direct voltage and a direct current of 40 A. The generator onboard the vessel therefore only needs to provide 220 alternating-current volts and the supply module 16 is a AC/DC convertor of small size.

The data transmission can possibly be carried out via carrier current in such a way that the cable 32 can be suppressed.

In this embodiment, the electrode 7 is more preferably arranged between the electrode 6 and the measuring sensors 8.

The data acquisition module 17 can advantageously carry out a first processing on the data measured and in particular generate values for the electrical resistivity of the seabed using the electrical potentials measured.

The applications of this system are multiple. It can be used to supply electrical data supplementing the geophysical data supplied by another system for exploring, for example an acoustic system for exploring. It can also be used when the acoustic systems for exploring are inoperative, for example when the seabed is highly reflective or in the presence of a pocket of dissolved gas. It can also be used to detect metal objects (highly conductive) or composites or plastics (highly resistive) in the seabed, and more particularly to detect and to locate, in particular in depth, infrastructures such as pipelines. In all of these applications, the voltage at which the current is injected into the marine environment is more preferably less than 60 volts in order to retain a compact supply module.

1. An electromagnetic system for exploring a seabed located in a marine environment comprising:
a current injection module that includes two injection electrodes separated from one another and configured to inject a current at a predetermined voltage into the marine environment close to the seabed and having a contact surface with the marine environment,
a data acquisition module that includes at least two measuring sensors for measuring electrical or magnetic data at least two points of the marine environment close to the seabed, wherein the data results from the conducting or from the inducing of the current into the seabed,
a supply module to supply power to the current injection module,
wherein each injection electrode includes one or more separate conductive elements electrically connected to each other and arranged in such a way as to form a conductive network or a multilayer conductive assembly having a large contact surface with the marine environment.

2. The system according to claim 1, wherein the contact surface of each injection electrode is equal to or greater than 0.5 m².

3. The system according to claim 1, wherein the contact surface of the two injection electrodes is dimensioned so that the electrical resistance of the two injection electrodes is less than 0.5 ohm.

4. The system according to claim 1, wherein each injection electrode has a volume of which the greatest length is less than or equal to 1.5 meter.

5. The system according to claim 1, wherein the voltage at which the current is injected into the marine environment is less than or equal to 60 volts.

6. The system according to claim 1, wherein each injection electrode includes a plurality of conductive elements arranged next to one another and electrically connected to each other in such a way as to form said multilayer assembly of conductive elements.

7. The system according to claim 6, wherein the conductive elements are metal plates arranged substantially parallel to each other.

8. The system according to claim 6, wherein the conductive elements are perforated and comprise a plurality of holes.

9. The system as claimed in claim 1, wherein the injection electrodes are made from a conductive material selected from the group consisting of brass, copper, stainless steel, graphite, titanium, platinum, and mixtures thereof.

10. The system as claimed in claim 1, wherein the injection electrodes are made from a porous conductive material.

11. The system according to claim 1, wherein each injection electrode includes a conductive element made of a metal fabric or from a porous conductive material.

12. The system as claimed in claim 1, wherein the contact surfaces of each of the two injection electrodes have substantially identical surface areas.

13. The system as claimed in claim 1, wherein the supply module is arranged in a sealed compartment of an undersea vehicle towed by a vessel and able to be moved in the marine environment close to the seabed.

14. The system according to claim 11, wherein one of the two injection electrodes is mounted on the undersea vehicle and the other injection electrode is mounted at the end of a trawl towed by the undersea vehicle.
